(19) United States
(12) Patent Application Publication
(10) Pub. No.: US 2011/0119515 A1
(43) Pub. Date: May 19, 2011

(54) Power Monitoring and Control System

(75) Inventors: Laurence P. Sadwick, Salt Lake City, UT (US); Walker T. Ford, Salt Lake City, UT (US); William B. Sackett, Sandy, UT (US)

(73) Assignee: InnoSys, Inc.

(21) Appl. No.: 12/775,458

(22) Filed: May 6, 2010

Related U.S. Application Data
(60) Provisional application No. 61/176,443, filed on May 7, 2009.

(51) Int. Cl. G06F 1/26

(52) U.S. Cl. 713/340

(57) ABSTRACT

A power monitoring system is disclosed which enables monitoring of power consumption and optionally control of power delivery. An embodiment of the power monitoring system includes a client device and a server device. The client device includes a power meter, a client-side microcontroller, and a client-side communication transceiver, for transacting with other clients or servers. The client-side microcontroller reads power usage statistics from the power meter and transmits them to the server device. The server device includes a server-side microcontroller that receives the power usage statistics from the client device. Some embodiments of the server-side microcontroller include a LAN/WAN interface, for public or private network access, and a software application that reports the power usage, and offers control opportunities to users on those networks.

### CROSS REFERENCE TO RELATED APPLICATIONS

The present application claims priority to U.S. patent application Ser. No. 61/176,443 entitled “Power Monitoring System”, filed May 7, 2009, the entirety of which is incorporated herein by reference for all purposes.

### BACKGROUND

Electricity is becoming more expensive while use of electricity continues to increase. Tracking and minimizing usage of electricity is a difficult task. For example, many electronic devices continue to consume electricity even when turned off. Low power factors in a home or other facility also increase the demand on municipal power systems, causing spikes in electrical current and requiring that the power systems be capable of supplying electricity at the spike level rather than just the average current level actually consumed.

### SUMMARY

The present invention provides a power monitoring system that may be used in a home or other location to monitor and control electricity consumption while controlling various devices such as lights and appliances. The power monitoring system may also include power factor monitoring and correction.

An embodiment of the power monitoring system includes a client device and a server device. The client device includes a power meter, a client-side microcontroller or, for example, an application specific integrated circuit (ASIC) or similar types of devices, circuits, implementations, etc., and a client-side wireless transceiver. The term microcontroller refers herein to microcontrollers, microprocessors, ASICs of any type and form, state machines, integrated circuits that perform similar and/or the same functions, etc. The client-side microcontroller reads power usage statistics from the power meter and transmits them to the server, or other client, device. The server device includes a server-side microcontroller that receives the power usage statistics from the client device. Communication transactions between clients and servers may occur over one or more wireless and/or wired mediums, including, but not limited to, over-the-air, over-the-powerlines, or over-additional-external-wiring. Communication transactions with the end-user occur through a software application interface, hosted on the server, which is accessible over public and private LAN/WAN infrastructures, through general web browsers or custom software applications. The server includes the LAN/WAN hardware interface. The server-side microcontroller includes a software application that reports the power usage statistics via Internet. The server device also includes a server-side wireless transceiver and an Internet interface.

In an embodiment of the power monitoring system, the client device also includes a driver circuit connected to the client-side microcontroller. The client device also includes a power input connected to the driver circuit, and a load output connected to the driver circuit. The client-side microcontroller is adapted to receive control commands from the server device and to configure the driver circuit based at least in part on the control commands.

In an embodiment of the power monitoring system, the client device also includes a light meter connected to the client-side microcontroller. The client-side microcontroller is adapted to configure the driver circuit based on a combination of the control commands and on an ambient light measurement from the light meter. In some embodiments, the light meter is an independent device.

In an embodiment of the power monitoring system, the client device also includes a motion detector connected to the client-side microcontroller. The client-side microcontroller is adapted to configure the driver circuit based on a combination of the control commands and on a signal from the motion detector. In some embodiments, the motion detector is an independent device.

In an embodiment of the power monitoring system, the driver circuit is adapted to drive a resistive load.

In an embodiment of the power monitoring system, the driver circuit is adapted to drive an inductive load.

In an embodiment of the power monitoring system, the client device also includes a client-side power line transceiver connected to the client-side microcontroller, and the server device also includes a server-side power line transceiver connected to the server-side microcontroller.

In an embodiment of the power monitoring system, the power usage statistics may include average input voltage, average input current, real-time input voltage, real-time input current, average output voltage, average output current, real-time output voltage, real-time output current, real power, apparent power, power factor, associated peak and root mean square (RMS) values, (if appropriate) dimming level, and on/off status.

In an embodiment of the power monitoring system, the server-side microcontroller is adapted to read electricity cost data from a power company.

In an embodiment of the power monitoring system, the server-side microcontroller is adapted to reduce electricity costs by causing the client device to configure the driver circuit to reduce power to the load output during peak electricity periods.

In an embodiment of the power monitoring system, the server-side microcontroller is adapted to receive commands from the power company to configure the driver circuit to reduce power to the load output.

In an embodiment of the power monitoring system, the server-side microcontroller is adapted to report power usage statistics for a plurality of client devices.

In an embodiment of the power monitoring system, the software application is adapted to enable grouping of a plurality of client devices and concurrent control of client device groups.

In an embodiment of the power monitoring system, the software application is adapted to enable scheduling of client device control.

In an embodiment of the power monitoring system, the software application is adapted to control client devices in response to events triggered by remote sensors.

In an embodiment of the power monitoring system, the client device also includes at least one manual control input connected to the client-side microcontroller. The client-side microcontroller is adapted to configure the driver circuit based on the manual control input.

In an embodiment of the power monitoring system, the client device also includes a power factor correction circuit connected to the power meter.

An embodiment of the power monitoring system also includes sensors such as light sensors, sound sensors, motion sensors, vibration sensors, liquid presence sensors, liquid flow sensors, magnetic sensors, position sensors, and orientation sensors.

In an embodiment of the power monitoring system, the software application is adapted to simulate occupancy by randomized control of the client device.

Another embodiment provides a power monitoring and control system, including a client device and a server device. The client device includes a driver circuit with a power input and a load output. The client device also includes a power meter, a light meter, and a client-side microcontroller. The client-side microcontroller is adapted to read power usage statistics from the power meter and to transmit them to the server device. The client-side microcontroller is also adapted to receive control commands from the server device and to configure the driver circuit based at least in part on the control commands and on an ambient light measurement from the light meter. The client device also includes a client-side wireless transceiver and a client-side power line transceiver. The server device includes a server-side microcontroller that is adapted to receive the power usage statistics from the client device. The server-side microcontroller includes a software application that is adapted to report the power usage statistics and to receive control commands via Internet. The server-side microcontroller is adapted to transmit the control commands to the client device. The server device also includes a server-side wireless transceiver, a server-side power line transceiver, and an Internet interface connected to the server-side microcontroller.

This summary provides only a general outline of some particular embodiments. Many other objects, features, advantages and other embodiments will become more fully apparent from the following detailed description, the appended claims and the accompanying drawings.

### BRIEF DESCRIPTION OF THE DRAWINGS

A further understanding of the various exemplary embodiments may be realized by reference to the figures which are described in remaining portions of the specification. In the figures, like reference numerals may be used throughout several drawings to refer to similar components.

FIG. 1 depicts a block diagram of a system for monitoring power usage and status and for controlling electrical devices.

FIG. 2 depicts a block diagram of a client-side portion of a system for monitoring power usage and status and for controlling electrical devices.

FIG. 3 depicts a block diagram of a server-side portion of a system for monitoring power usage and status and for controlling electrical devices.

### DESCRIPTION

A power monitoring system is disclosed herein that monitors and controls electricity consumption. The power monitoring system disclosed herein may be used in conjunction with a sophisticated power grid if desired, enabling a user to shift consumption of electricity to off-peak periods as well as to minimize overall electricity consumption. The power monitoring system includes one or more power meters, such as a watthour meter, that may be installed in a home or other facility to monitor overall power consumption, and installed in every outlet, every light dimmer, every switch, etc., or in selected locations. The power meters may be adapted merely to monitor power usage or may be adapted to control power usage as well by dimming or reducing the power output through the power meter in any suitable manner. For example, the power meters may employ phase clipping, amplitude reduction, or any other suitable technique to reduce power output.

The results from the power meters may be accessed and viewed via any suitable interface. In one embodiment, the power meters may be accessed using a web server that gathers data from the power meters and makes the data available on a local area network (LAN) or Internet connection using a web browser application on a computer, personal digital assistant (PDA) or cellular telephone or by other wireless means.

The power consumption reported by the power monitoring system may be compared with the main electricity meter to the house or other facility if desired and allow various levels of decision making to take place along with auditing and power/energy management control, data analysis, and evaluation, etc.

Some embodiments of the power monitoring system enable cooperation with the power company to automatically reduce power consumption during peak power consumption periods by automatically dimming lights and automatically turning off power to non-essential devices. Configuration of these power consumption settings or preferences may be stored in a file on a server in the home or in any other suitable device. In some embodiments, information may be retrieved from the power company defining peak and non-peak hours. Information may also be transmitted from the power company to the power monitoring system during brownout periods, either automatically minimizing power consumption in the home by reducing power through selected power meters in the power monitoring system or turning off electricity through power meters to nonessential devices including browning down/out appropriate types of electrical energy consumers. This cooperation may also be voluntary by configuring power consumption settings for each of a number of power conditions from the power company. The power monitoring system may thus include a complex infrastructure for controlling and monitoring power consumption in a home or other location, while remaining simple to access and configure using a web browser or other interface. For example, in addition to the consumption settings discussed above, the power monitoring system may measure and display voltage and/or current waveforms, power factor information, etc., for the entire home as well as for individual outlets and switches. In addition, the power monitoring system can detect the position and setting of the dimmers and switches connected to the system including remotely detecting the manually set dimming level of all dimmers attached to the system. Top power consumers in the home may be identified, for example by graphically displaying the power used by refrigerators, washers and dryers, stoves, audio/visual equipment, computers, lighting, etc. Various power/energy consumption rates may be entered into the system with the system having a selected priority process for determining which electrical power consumers/appliances in the house should be turned off or dimmed depending on the details of the power/energy pricing rates and schedules. The power monitoring control system could also include secure means to provide electronic forms of payment to, for example, the utility company(ies). In addition, the detailed power usage for the customer could be stored on the customer's mass storage, the utilities' mass storage or a third party's mass storage facilities. Such storage of information could also be used to provide a basis for rental/lease fee arrangements where an equipment provider could lease the power monitoring system to a customer in return for a percentage of the energy savings and associated costs that the customer benefits from having the power monitoring and control system.

The power monitoring system may also include power factor correction, either globally with, for example, a bank of capacitors at the power mains to a building or locally at each device or outlet. This smooths the power consumption, reduces reactive power losses, and assists in reducing current spikes and helping prevent overheating and power waste in power lines.

The power monitoring system may also minimize power consumed by devices when in a standby mode such as televisions and other audio/visual equipment. The power monitoring system may be configured to fully power down the equipment at certain time periods, or manually by a command through the web browser interface or using a button or other interface on the power meter device itself, or by turning off power when electricity is being consumed but falls under a predetermined threshold level or by using remote sensors such as motion, voice, audio, visual, etc that are wireless and wired connected to the system. Electricity may then be fully restored by a command through the interface or using a button on the power meter device.

The power monitoring system also provides remote access to power usage in the home via the web browser interface, enabling the user, for example and not limited to, to control and to turn lights on and off, to determine whether a device has been left on by monitoring actual power usage through an associated power meter, and to turn off power to a device if it has been left on and to, for example, determine if a light has ceased to work or burned out. Radios or other devices may be turned on remotely when away from the home to simulate occupancy of the home. Such turning on may also be done in conjunction with various types of sensors including but not limited to light, sound, motion, visual, audio, vibration, liquid, spill and displacement, magnetic, etc. sensors. This type of activation of lights and sound generating devices to simulate occupancy may also be programmed and/or randomized using the web browser interface in some embodiments.

In some embodiments, the power monitoring control system may also include sensors and/or detectors to indicate whether doors or windows are closed and/or locked, including a sensor or set of sensors on a garage door indicating whether the garage door is in a vertical or horizontal position to report whether the garage door is open or closed, along with video cameras, sound and motion sensors and/or detectors, general security detectors and/or sensors, and sensors and/or detectors to monitor water flow or potential water leaks or some subset of the above. The potential list of sensors and/or detectors displayed above is meant to provide examples of possible configurations and is in no way meant to be limiting for the present invention.

The power monitoring system may be used to regulate access to computers, television and games for children, enabling power outlets only during scheduled times.

In summary, the power monitoring system is a monitoring as well as control system, in enough depth to enable power consumption comparisons with the main kilowatt hour meter for a building or dwelling, whether residential or industrial, in some embodiments. The power monitoring system may in some embodiments include a link to the utility company to download price rates during various time periods, peak and off times, seasonal rates, etc., displaying the cost of actual power consumption and enabling control power to devices based on these scheduled rates. For example, and interface to the power monitoring system may be included in devices such as dishwashers, washing machines, dryers, and other such appliances, turning them on and initiating a wash cycle during off times to benefit from lower electricity rates. It may also include other systems such as air conditioners and heating, ventilation and air conditioning (HVAC) systems in general including the controls and vents for such, refrigerators, and refrigeration units, and the other such appliances and electronics that can are amenable to, for example, being dimmed or browned out. It can also be used to monitor water and fluid based systems and provide appropriate feedback, alerts, or control depending on the details of the particular implementation.

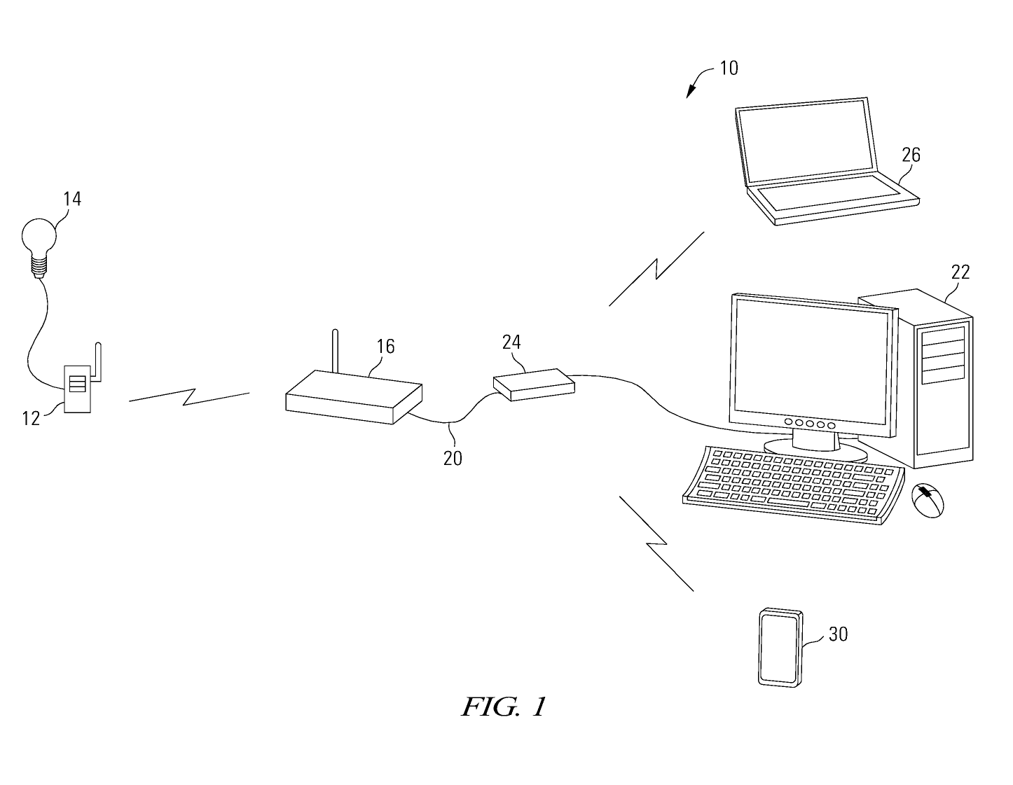

A block diagram of a power monitoring system 10 according to one embodiment is illustrated in FIG. 1. A client device 12 is connected to a load 14 which may be any electrical device or devices, such as a light or appliance. The client device 12 is connected with a power source such as being plugged into a residential power socket or connected to a battery to power the load 14. The client device 12 communicates wirelessly with a server device 16, which includes an Internet interface 20 and a software application that may be accessed for example by web browsers. In one embodiment, the software application comprises a web application. The server device 16 may be connected to a desktop computer 22 through a router 24, or to a laptop computer 26, (as an example) a mobile phone 30 which could also be a smart phone, a personal digital assistant, a remote control, etc.), or any other Internet enabled device, whether through a wired or wireless connection. In one example, the wireless connection between the client device 12 and the server device 16 uses the IEEE 802.15.4 standard for low-rate wireless personal area networks (LR-WPANs).

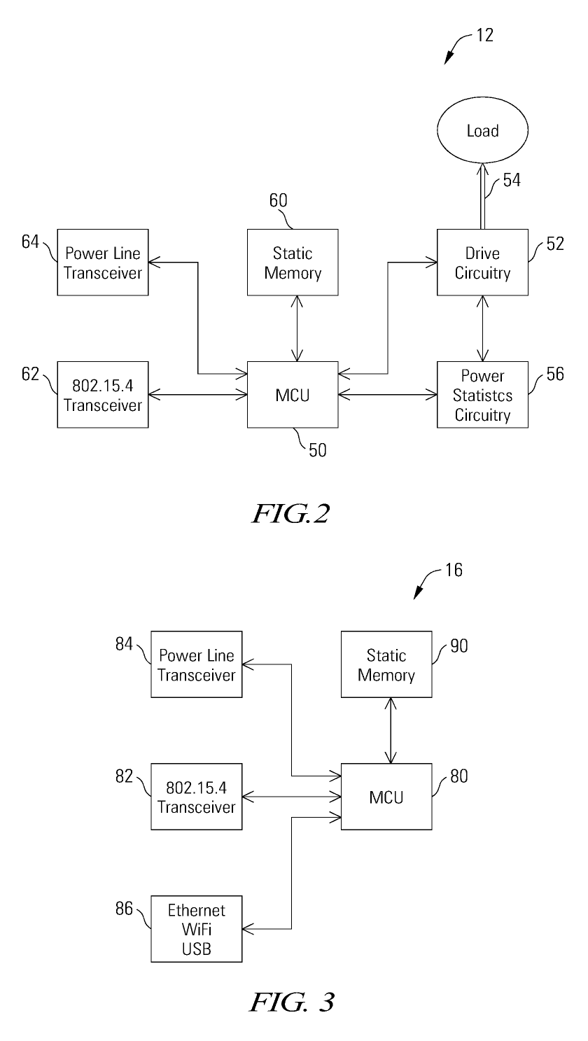

The client device 12 is illustrated in more detail in the block diagram of FIG. 2. A microcontroller (MCU) 50 controls drive circuitry or a driver circuit 52 which powers a load output 54. Note that microprocessors and/or microcontrollers (e.g., 50) described herein may replaced in various embodiments with other suitable control devices, such as state machines, digital logic, analog and digital logic, application specific integrated circuits (ASICs), gate arrays, configurable logic devices (CLDs), etc. A power meter 56 measures power usage statistics from the drive circuitry 52 and reports them to the microcontroller 50, which in turn reports them to the server device 16. The power usage statistics may be retrieved from the server device 16 by a web interface on any suitable device such as a home computer 22, laptop computer 26 or mobile phone 30, etc. The power usage statistics may be stored in a static memory 60 in the client device 12 and transmitted to the server device 16 using a wireless transceiver 62, a power line transceiver 64, a wired connection or any other desired connection mechanism. Software/firmware may also be stored in the static memory 60 to be executed by the microcontroller 50. The client device 12 may also include manual buttons enabling all functions performed in the client device 12 to be manually operated, such as dimming or turning on and off the power to the load.

The drive circuitry 52 may be customized to drive specific types of electrical loads, e.g., duty cycle control of resistive loads such as lighting, or on-off control of inductive loads such as appliances, motors, etc. The power usage statistics may include measuring both average and real-time input voltage and current, output voltage and current, etc. The microcontroller 50 is able to derive, save and report real power (W), apparent power (VA), the power factor (PF), the dynamic power factor or true power factor even during dimming of lights, where statistics like min, max, average and trending may be reported along with other information. The present invention can also perform the functions and operations of a typical thermostat.

The server device 16 is illustrated in more detail in the block diagram of FIG. 3. A microcontroller 80 hosts software for communications networks such as a wireless transceiver 82 and power line transceiver 84 used to communicate with client devices (e.g., 12) and Ethernet, WiFi,

USB or other systems 86 for communicating with users. The microcontroller 80 also hosts software for a software application providing a user interface. Because the software application is hosted in the server device 16, no software or drivers are required to be installed on user devices such as a home computer 22, laptop computer 26 or mobile phone 30 other than a web browser. The server device 16 also includes static memory 90 to store power usage statistics and to meet other data storage needs. The software application enables users to organize, control and read data from wireless client devices. Organization of client devices may be realized through visual grouping in the software application, which allows logical control of multiple devices. Device functions may be assigned to various forms of automatic control, including scheduling and response to remote sensing events. The software application may be accessed with any type of web-enabled device, whether locally or abroad.

While illustrative embodiments have been described in detail herein, it is to be understood that the concepts disclosed herein may be otherwise variously embodied and employed.

What is claimed is:

1. A power monitoring system, comprising:
a client device and a server device, the client device comprising:
a power meter;
a client-side microcontroller connected to the power meter, the microcontroller being adapted to read power usage statistics from the power meter and to transmit them to the server device;
a client-side wireless transceiver connected to the client-side microcontroller; and
the server device comprising:
a server-side microcontroller being adapted to receive the power usage statistics from the client device, the server-side microcontroller having a software application adapted to report the power usage statistics via Internet;
a server-side wireless transceiver connected to the server-side microcontroller; and
an Internet interface connected to the server-side microcontroller.

2. The power monitoring system of claim 1, wherein the client device further comprises a driver circuit connected to the client-side microcontroller, the client device further comprising a power input connected to the driver circuit, and a load output connected to the driver circuit, wherein the client-side microcontroller is adapted to receive control commands from the server device and to configure the driver circuit based at least in part on the control commands.

3. The power monitoring system of claim 2, the client device further comprising a light meter connected to the client-side microcontroller, wherein the client-side microcontroller is adapted to configure the driver circuit based on a combination of the control commands and on an ambient light measurement from the light meter.

4. The power monitoring system of claim 2, the client device further comprising a motion detector connected to the client-side microcontroller, wherein the client-side microcontroller is adapted to configure the driver circuit based on a combination of the control commands and on a signal from the motion detector.

5. The power monitoring system of claim 2, wherein the driver circuit is adapted to dim an attached light.

6. The power monitoring system of claim 2, wherein the driver circuit is adapted to drive one of an inductive load and a resistive load.

7. The power monitoring system of claim 1, the client device further comprising a client-side power line transceiver connected to the client-side microcontroller, the server device further comprising a server-side power line transceiver connected to the server-side microcontroller.

8. The power monitoring system of claim 1, wherein the power usage statistics comprise at least one element selected from the group consisting of average input voltage, average input current, real-time input voltage, real-time input current, average output voltage, average output current, real-time output voltage, real-time output current, real power, apparent power, power factor, and on/off status.

9. The power monitoring system of claim 2, wherein the server-side microcontroller is adapted to read electricity cost data from a power company.

10. The power monitoring system of claim 9, wherein the server-side microcontroller is adapted to reduce electricity costs by causing the client device to configure the driver circuit to reduce power to the load output during peak electricity periods.

11. The power monitoring system of claim 10, wherein the server-side microcontroller is adapted to receive commands from the power company to configure the driver circuit to reduce power to the load output.

12. The power monitoring system of claim 1, wherein the server-side microcontroller is adapted to report power usage statistics for a plurality of client devices.

13. The power monitoring system of claim 2, wherein the software application is adapted to enable grouping of a plurality of client devices and concurrent control of client device groups.

14. The power monitoring system of claim 2, wherein the software application is adapted to enable scheduling of client device control.

15. The power monitoring system of claim 2, wherein the software application is adapted to control client devices in response to events triggered by remote sensors.

16. The power monitoring system of claim 1, wherein the client device further comprises at least one manual control input connected to the client-side microcontroller, wherein the client-side microcontroller is adapted to configure the driver circuit based on the manual control input.

17. The power monitoring system of claim 1, wherein the client device further comprises a power factor correction circuit connected to the power meter.

18. The power monitoring system of claim 2, further comprising at least one sensor selected from the group consisting of light sensors, sound sensors, motion sensors, vibration sensors, liquid presence sensors, liquid flow sensors, magnetic sensors, position sensors, and orientation sensors.

19. The power monitoring system of claim 2, wherein the software application is adapted to simulate occupancy by randomized control of the client device.

20. A power monitoring and control system, comprising:
a client device and a server device, the client device comprising:
a driver circuit;
a power input connected to the driver circuit;
a load output connected to the driver circuit;
a power meter connected to the driver circuit;
a light meter;
a client-side microcontroller connected to the power meter and to the driver circuit and to the light meter, the client-side microcontroller being adapted to read power usage statistics from the power meter and to transmit them to the server device, the client-side microcontroller being further adapted to receive control commands from the server device and to configure the driver circuit based at least in part on the control commands and on an ambient light measurement from the light meter;
a client-side wireless transceiver connected to the client-side microcontroller; and
a client-side power line transceiver connected to the client-side microcontroller; and
the server device comprising:
a server-side microcontroller being adapted to receive the power usage statistics from the client device, the server-side microcontroller having a software application adapted to report the power usage statistics and to receive control commands via Internet, the server- side microcontroller being adapted to transmit the control commands to the client device;
a server-side wireless transceiver connected to the server-side microcontroller;
a server-side power line transceiver connected to the server-side microcontroller; and
an Internet interface connected to the server-side microcontroller.
